(19) United States
(12) Patent Application Publication
(10) Pub. No.: US 2010/0098942 A1
(43) Pub. Date: Apr. 22, 2010

(54) COVER FOR PROTECTING A PAINTED SURFACE

(75) Inventors: MIECZYSLAW (MICHEL) STACHNIK, Luxembourg (LU); ERIC HUEBSCH, Contern (LU)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/603,061

(22) Filed: Oct. 21, 2009

Related U.S. Application Data
(60) Provisional application No. 61/107,016, filed on Oct. 21, 2008.

(51) Int. Cl. B32B 33/00

(52) U.S. Cl. 428/351

(57) ABSTRACT

A cover for protecting a partially cured paint surface comprising: a, breathable membrane and an adhesive tape for attaching the cover to the paint surface wherein the tape comprises a permanent adhesive layer covering the inner surface of the membrane along the peripheral edge of the cover, a removable adhesive layer that contacts the painted surface and a carrier layer positioned between the permanent adhesive layer and the removable adhesive layer.

### BACKGROUND OF THE INVENTION

1. Field of the Invention

The present invention relates to a cover for protecting a painted surface.

2. Description of the Related Art

Newly painted cars need protection from the elements, both natural and man-made during storage and/or transit. After the cars have left the paint shop and have cooled down, it may well be that the protection layer will be put in place one hour after having left the oven. Furthermore, this protection membrane may remain on the car over six month under all possible weather conditions. Those are the surroundings under which the protection membranes as well as the different associated adhesive formulations have to protect the different clear coats. Sometimes the protection is provided by wax which has to be removed. Environmental laws in some countries now prohibit the use of these waxes. Protection is often provided by temporary synthetic fabric covers over major surfaces such as the roof, hood and trunk lid. However these covers are typically applied before the paint has fully cured and the covers themselves can cause unacceptable marks on the surface of the paint. Some of the recently developed paints have been shown to be more susceptible to such marking.

Indian Patent No. 206879 (Joo) discloses a vehicle cover comprising a breathable polyethylene fibrous substrate with a peripheral double-sided tape for protecting the surface of a vehicle from dust and rust. Vehicle covers according to Joo have been found to mar the paint finish upon removal of the covers.

### BRIEF DESCRIPTION OF THE DRAWINGS

FIG. 1 is a cross-sectional view of the double sided, differential adhesive tape is attached to the edge of the protective cover of the invention.

### DETAILED DESCRIPTION OF THE INVENTION

As a result of the disadvantages associated with some existing protective covers, there is a need for an improved cover that not only protects the painted surface, but also does not mark the surface, which has been particularly problematic with some of the recently developed finishes.

The protective cover of the invention provides mechanical strength and protection for the delicate paint film with a dual purpose membrane cut to the appropriate shape and size for the intended area of paint film to be protected and a multilayer, differential adhesive tape along the inner, peripheral edge of the membrane for attaching the protective cover to the paint film. Furthermore, according to one embodiment of the cover of the invention, the cover provides high reflectance of incident light.

The membrane of the cover of the invention serves the dual purpose of acting as a protective layer and as a breathable layer. The membrane protects the paint finish from contact with external contamination, liquid water (including rain), exposure to sunlight and damage caused by the impact of debris and particulate matter.

The membrane is “breathable” in that the membrane allows moisture vapor to pass through as well as allowing volatile compounds to escape from the paint film through the protective cover. Through the use of a breathable membrane, the cover of the invention provides for the evaporation of trapped moisture and other compounds between the cover and the paint finish, eliminating the incidence of stains to the paint finish caused by moisture. The membrane has a moisture vapor transmission rate between about 500 g/m² per 24 hours and about 5000 g/m² per 24 hours. The air permeability of the membrane as measured by Gurley Hill porosity is less than about 25 seconds. The membrane is also liquid impermeable, having a hydrostatic head of at least 140 cm.

The membrane further advantageously serves the purpose of acting as a reflective layer. The membrane has a high degree of light reflectance characterized by scattering of incident light, so that the protective cover of the invention reduces heat buildup in the partially cured paint finish on the vehicle, thereby providing uniform, forgiving curing conditions for the covered paint finish. The membrane advantageously has a reflectance of greater than about 85%, even greater than about 90%, even greater than about 95% and even greater than about 98%.

The membrane advantageously comprises a flash-spun plexifilamentary film-fibril sheet, such as high density polyethylene sheet commercially available from E. I. du Pont de Nemours & Co., Wilmington, Del. (hereafter DuPont) under the trade name Tyvek®. The flash-spun sheet can alternatively be formed of a polymer selected from the group consisting of polyethylene, polypropylene, polyesters, acetyl polyoxymethylene resin and polyamides. Each flash-spun layer in the membrane is between about 5 mils and about 15 mils in average thickness. Two or more membrane layers can be used for increased opacity, reflectance or mechanical stiffness.

The membrane has sufficient mechanical integrity to demonstrate good durability in use. The tensile strength of the membrane is advantageously between about 7 lb/in and about 72 lb/in as measured according to ASTM D5035. The elongation to break of the membrane is advantageously between about 10% and about 28% is measured according to ASTM D5035. The Elmendorf tear strength of the membrane is advantageously between about 0.5 lb and about 1.3 lb as measured according to ASTM D1424. The delamination strength of the membrane is advantageously between about 0.08 lb/in and about 0.8 lb/in as measured according to ASTM D2724.

The surface energy of the membrane is lower than the surface energy of the paint finish. The difference in surface energy dictates the requirements of the adhesives used in the double sided tape. Because of the lower surface energy of the membrane, the adhesive in contact with the membrane must have a higher peel strength than the peel strength of the adhesive in contact with the paint finish.

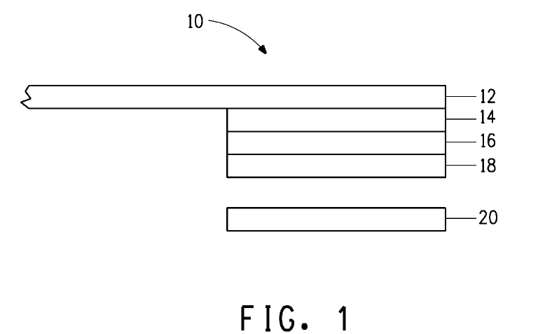

When used on a vehicle, in one embodiment as depicted in FIG. 1, the protective cover 10 of the invention is held in place on the paint finish by a multilayer, differential adhesive tape 15 positioned along the peripheral edge of the membrane and which is attached to the inner surface of the membrane. The tape comprises a permanent adhesive layer 14 for attaching the tape to the membrane, a removable adhesive layer 18 for attaching the protective cover to the vehicle paint finish and a carrier layer 16 between the permanent adhesive and the removable adhesive layers. The term “permanent” means generally that the attachment to the membrane of the protective cover is such that the tape does not detach in normal use. In contrast, the term “removable” means that the attachment to the clear coat is such that the tape holds the protective cover on the painted surface but can be removed by hand with relative ease when the cover is no longer required. Typically, for ease in handling a release layer 20 is attached to the removable adhesive layer

The permanent adhesive forms a permanent bond between the carrier layer and the membrane. The peel strength between the permanent adhesive layer and the membrane is at least about 10 N/cm. Suitable permanent adhesives include acrylic-based adhesives, rubber-based adhesives including butyl rubber and styrene butadiene rubber, hot melt adhesive, and block copolymer adhesives. The permanent adhesive layer has a thickness between about 20 micrometers and about 60 micrometers.

The removable adhesive is chemically nonreactive with the paint finish. The removable adhesive layer has relatively low modulus, in the range between about 1×10⁴ dynes/cm² and about 1×10⁶ dynes/cm² or even in the range between about 1×10⁵ dynes/cm² and about 3×10⁵ dynes/cm². The peel strength at the interface between the removable adhesive and the paint finish is between about 2 N/cm and about 7 N/cm, which is lower than the peel strength of the interface between the permanent adhesive and either the carrier layer or the membrane. Likewise, the peel strength of the interface between the removable adhesive and paint finish is lower than the peel strength of the interface between the removable adhesive and the carrier layer. When the cover is removed from the paint surface, it separates from the painted surface of the vehicle cleanly while the cover itself remains intact. Suitable removable adhesives include rubber-based adhesives including butyl rubber and styrene butadiene rubber, block copolymer adhesives, acrylic-based adhesives and hot melt adhesives. Medical grade adhesives that have no or very little additives may be suitable as the removable adhesive. The removable adhesive layer has a thickness between about 30 micrometers and about 80 micrometers.

The carrier layer prevents migration of adhesive between the permanent and removable adhesive layers. The carrier is advantageously a low modulus, low-stiffness film (e.g., polyethylene or polyurethane) or a low-stiffness foam layer. The carrier layer has a tensile modulus of about 1×10⁷ Pa at 80° C. and about 5×10⁹ Pa at −40° C.

Some clear coat formulations lose their stiffness when the ambient temperature exceeds the glass transition temperature of the respective clear coat, therefore there viscoelastic properties should be taken into account. The carrier layer should have a low tensile modulus to avoid markings on the clear coat. Likewise, the modulus of the removable adhesive is important for a good performance on the overall surface aspect. Its tensile modulus should be in the same range as the tensile modulus of the clear coats at temperatures that are higher than the glass transition temperature (T_{G}) of the clear coats. The tensile modulus has to be low in the range of the T_{G} of the clear coat as well to ensure that the adhesive adapts to the clear coat and not have the clear coat adapt to the removable adhesive. As such, little or no marking will be left on the clear coat surface after peel off of the protective cover. Providing the appropriate modulus of the different constituents of the double-sided tape of the various embodiments of the inventive covers achieves good performance under various circumstances, such as temperature, humidity, UV exposure, etc.

The surface energy of the carrier should be significantly higher than the surface energy of the paint film and advantageously should exceed about 55 dynes/cm. For use with paint films having a surface energy less than about 50 dynes/cm, the surface energy of the carrier is advantageously about 70 dynes/cm. This difference in surface tension permits the protective cover to be peeled from the paint film without transferring the removable adhesive layer from the carrier to the paint film.

Suitable films for use as the carrier layer include polyethylene, polyurethane, polypropylene, polyester-polyether copolymer such as Hytrel®, (available from DuPont) and polymethylpentene (PMP).

Before the tape is applied to the membrane, the inner surface of the membrane onto which the tape is applied can be subjected to corona treatment in order to improve the adhesion of the permanent adhesive layer to the membrane. There is an increase in the initial peel strength due to corona treatment of the membrane. This enhanced initial peel strength eliminates potential rupture (failure) at the interface of the membrane and permanent adhesive when peeling off the membrane with the double sided adhesive

According to another embodiment of the invention, an additional peripheral edge tape can be applied to the inner surface of the membrane of the cover in order to provide a more secure attachment to the vehicle during use.

The peripheral tape may be covered by a release liner. The surface of the release liner in contact with the removable adhesive layer must be well cured, smooth and flat in order to minimize the risk of forming defects such as craters in the paint finish. The release layer must also have a low peel strength to avoid contamination of the removable adhesive.

### EXAMPLES

The following are descriptions of working examples of embodiments of the inventive and comparative examples, which will include various types of covers as well as adhesive tapes that are used to hold the cover on the painted surfaces.

### Covers

### Comparative Example 1

Rapgard, from Nitto Denko, Japan is a protective film with a total thickness of 50 micrometers where the polyolefin film is 35 micrometers thick and the rubber adhesive is 15 micrometers thick. The adhesive covers the entire protective film.

### Comparative Example 2

Bodyguard, available from Tesa AG Hamburg, Germany is made of a polyolefin adhesive film with a rubber adhesive layer that covers the entire protective film.

### Tapes

Comparative Tape 3 BOWTAPE I, available from BOWTAPE CO: LTD.(KOREA) is a double sided differentiated acrylic tape with PET carrier and release liners.
Comparative Tape 4 BOWTAPE II, available from BOWTAPE CO: LTD.(KOREA) is a double sided differentiated acrylic tape with PET carrier and release liners. BOWTAPE II has a higher concentration of tackifier in the removable adhesive.

The double sided tapes in following examples 5-11 are available from Adhesives Research Ireland Ltd., Limerick, Ireland and comprise a “removable” rubber adhesive layer and a “permanent” acrylic adhesive layer with a carrier layer sandwiched between the rubber and acrylic layers. The tapes also have silicone coated release liners applied to each outer adhesive surface of the tape.

Example Tape 5 rubber 25 micrometers thick, polyethylene terephthalate (PET) carrier 32 micrometers thick, acrylic 25 micrometers thick.
Example Tape 6 rubber 25 micrometers thick, polyethylene terephthalate (PET) carrier 32 micrometers thick, acrylic 50 micrometers thick.
Example Tape 7 rubber 50 micrometers thick, polyethylene terephthalate (PET) carrier 32 micrometers thick, acrylic 50 micrometers thick.
Example Tape 8 rubber 25 micrometers thick, polyethylene (PE) carrier 32 micrometers thick, acrylic 50 micrometers thick.
Example Tape 9 rubber 50 micrometers thick, PE carrier 32 micrometers thick, acrylic 50 micrometers thick.
Example Tape 10 rubber 50 micrometers thick, PE (with TiO2 filler or UV absorber) carrier 32 micrometers thick, acrylic 50 micrometers thick.
Example Tape 11 rubber 50 micrometers thick, PE carrier 32 micrometers thick with TiO2 filler; acrylic 50 micrometers thick with UV absorber.

### Protective Covers

### Examples 13-21

The protective sheet is Tyvek® flashspun polyethylene supplied by DuPont de Nemours, Luxembourg and the tapes are as described above:

| | |
|---|---|
| Comparative Example 13 | sheet with Comp Tape 3 |
| Comparative Example 14 | sheet with Comp Tape 4 |
| Example 15 | sheet with Example Tape 5 |
| Example 16 | sheet with Example Tape 6 |
| Example 17 | sheet with Example Tape 7 |
| Example 18 | sheet with Example Tape 8 |
| Example 19 | sheet with Example Tape 9 |
| Example 20 | sheet with Example Tape 10 |
| Example 21 | sheet with Example tape 11 |

The following paint clear coats were used in the evaluation of various examples of protective covers of the invention and comparative examples. Each clear coat is designated as follows, wherein those having one component are designated as “1K” and those having two components are designated as “2K”.
Coat A: 1K acryl-melamine resin clear coat.
Coat B: 2K polyester clear coat with hexamethylene diisocyanate (HDI) as a hardener.
Coat C: 2K polyester clear coat with isophorone diisocyanate (IPDI) as a hardener.
Coat D: 2K scratch resistant clear coat with different reticulation mechanism either OH-NCO or OH-melamine.
Coat E: 2K acrylic clear coat.
Coat F: Standard top coat containing alkyd acrylate with a melanin cross-linker.

In the Examples below, the paint finishes were cured under the following conditions, as designated:

| | |
|---|---|
| Under Baking | 25 minutes at 125° C. |
| Standard Baking | 30 minutes at 140° C. |
| Over Baking | 30 minutes at 160° C. |

### Evaluations

The Working Examples and Comparative Examples were subject to various conditions and then tested as described further below.

### Evaluation I:

### A. Weatherization Test:

This test serves to simulate the reality at the assembly of the different car manufacturers.

The protective cover was applied one hour after the curing step of the clear coat. The permanent adhesive side of the tape was adhered to the protective cover 24 hours before application onto the paint finish and the removable adhesive side was adhered to the clear coat immediately after peeling the release liner. The sample size was 2 cm wide and 7 cm long.

The samples were subjected to simulated accelerated weather conditions in accordance with PV1200, a procedure developed by Volkswagen. The test consisted of 5 days in a chamber at 40° C. and 100% humidity followed by 5 days with 10 cycles between −40° C. and +80° C. A cycle consists of, for example, 4 hours at −40° C., then a transition period of 2 hours to +80° C. and holding 4 hours, then a transition period of 2 hours back to 40° C.

The peel strength was measured before and after the weatherization test and cured by Standard Baking. The determination of the peel strength was performed on a Z 2.5 machine with a load cell of 100N, available from Zwick GmbH, Ulm Germany. The test sample was positioned such that the generated peel angle was 180°. The peel speed was 300 mm/min and the chosen width of the sample was 2.0 cm. The measurements were conducted at a temperature of 21° C. and the ambient humidity was controlled to around 50% and are presented in N/cm in the following Table 1.

TABLE 1

| | Coat A | | Coat B | | Coat C | |
|---|---|---|---|---|---|---|
| | before | after | before | after | before | after |
| Comp Ex 1 | 4.0 | 0.5 | 4.6 | 0.9 | n.a. | n.a. |
| Comp Ex. 2 | 0.7 | 1.3 | 1.1 | 2.9 | 1.2 | 2.0 |
| Comp Ex. 13 | 2.9 | 3.8 | 4.3 | 4.8 | 5.8 | 5.6 |
| Comp Ex 14 | 3.7 | 17.1 | 4.8 | 12.3 | 5.8 | 12.5 |
| Example 15 | 4.1 | 3.7 | 2.6 | 3.2 | 6.0 | n.a. |
| Example 16 | 4.1 | 3.2 | 4.1 | 4.2 | 6.0 | 5.5 |
| Example 17 | 3.7 | 3.2 | 3.1 | 3.3 | 4.6 | 5.2 |
| Example 18 | 4.3 | 3.3 | 4.3 | 4.6 | 4.6 | 5.1 |
| Example 19 | 5.7 | 4.2 | 5.5 | 5.5 | 5.3 | 5.0 |
| Example 21 | 6.7 | 3.6 | 5.7 | 3.0 | 6.2 | 7.2 |

After the weatherization step, the surface of the clear coats was analyzed by the un-aided eye for surface defects and by an optical profile microscope for profile measurements (on the edges around the tape periphery).

In the visual inspection, the following rating system applied wherein the first rating digit is the surface aspect of the clear coat (with curing by Under Baking) underneath the adhesive. The second rating digit is the surface aspect at the edge of the strip of the protective cover.

The rating scale was:

0—no visible defect; 1—very small defect; 2—clearly visible defect; 3—very obvious defect; 4—strong defect; 5—extreme defect.
The results are presented in the following Table 2.

TABLE 2

| | Coat A | Coat B | Coat C |
|---|---|---|---|
| Comp Ex. 1 | 0/4 | 1/2 | n.a. |
| Comp Ex. 2 | 0/2 | 1/2 | 1/2 |
| Comp Ex. 13 | 4/3 | 3/2 | 4/3 |
| Comp Ex. 14 | 4/4 | 4/4 | 4/4 |
| Example 15 | 2/2 | 0/1 | 1/2 |
| Example 16 | 2/3 | 1/1 | 0/2 |
| Example 17 | 2/3 | 1/1 | 0/2 |
| Example 18 | 1/3 | 1/1 | 0/1 |
| Example 19 | 0/1 | 0/1 | 0/1 |
| Example 21 | 0/2 | 0/1 | 0/0 |

The optical profile was measured by an optical profiler providing three-dimensional surface profile measurements without contact by a Wyko NT1100, available from Veeco Instruments BV, Breda, Netherlands.

The profile analysis was done on clear coats with curing by Standard Baking. The measured profile height on the edge of the covered surface is defined by the maximum of the peak height in micrometers and are presented in the following Table 3.

TABLE 3

| | Coat A | Coat B | Coat C | Coat E |
|---|---|---|---|---|
| Comp Ex. 2 | 1.1 | 0.9 | 0.4 | 0.3 |
| Example 15 | 1.1 | 0.6 | 1.3 | 1.7 |
| Example 16 | 2.1 | 0.3 | 0.8 | 0.9 |
| Example 17 | 1.5 | 0.4 | 0.8 | 0.5 |
| Example 18 | 0.6 | 0.6 | 0.4 | n.a. |
| Example 19 | 0.6 | 0.3 | 0.2 | 0.6 |

Evaluation II Durability under Ultraviolet Radiation Exposure

When applied to a freshly painted clear coat, the protective cover is not only exposed to humidity and temperature changes, but also to strong UV irradiation, especially in the summer.

The UV irradiation impact on the adhesive was quantified by measuring the peel strength as a function of time of exposure (at 400, 800, 1200 and 1600 hrs) according to PV3039, which is a standard developed by Volkswagen. The test was performed on plates of 7.5 cm×7.5 cm (prepared as in Evaluation I). The protective cover strip samples (2 cm×7 cm) were adhered one hour after being taken out of the oven. In order to achieve a uniform adhesion, the same weight was applied to the strip samples of the protective covers using a 2 kg stainless steel bar with a diameter of 50 mm and a length of 150 mm.

The samples are then being placed inside a Ci4000 Xenon Weather-Ometer® (available from Atlas Material Testing Technology, Chicago, Ill.) and were exposed to a xenon lamp possessing a borosilicate filter and a power of 0.51 W/(m² nm) at 340 nm. The samples were also exposed to a sprinkler sequence which was active for 18 min and then inactive for 102 min. The water of this sprinkler should not exceed a conductivity of 0.1 micro-second at room temperature. The sample temperature was regulated at 65° C. (black sample) and the room temperature was regulated at 38° C. The relative humidity of the air was regulated at 60% during the dry phase and 95% during the active sprinkler phase.

Visual inspection as described in Evaluation I was performed on panels with curing by Standard Baking and the results are presented in the following Table 4.

TABLE 4

| | Coat A | | | | Coat B | | | | Coat C | | | |
|---|---|---|---|---|---|---|---|---|---|---|---|---|
| | 0 h | 400 | 800 | 1600 | 0 h | 400 | 800 | 1600 | 0 h | 400 | 800 | 1600 |
| Comp Ex. 1 | 0-0 | 0-1 | 2-2 | 3-2 | 0-0 | 0-0 | 0-0 | 0-1 | 0-0 | 0-1 | 3-1 | 0-1 |
| Comp Ex. 2 | 0-0 | 0-1 | 0-1 | 2-2 | 0-0 | 0-1 | 0-0 | 0-0 | 0-0 | 0-1 | 3-1 | 0-1 |
| Comp | n.t. | n.t. | n.t. | n.t. | n.t. | n.t. | n.t. | n.t. | 0-0 | 1-1 | 2-1 | 3-1 |
| Ex. 13 | | | | | | | | | | | | |
| Comp Ex. | n.t. | n.t. | n.t. | n.t. | n.t. | n.t. | n.t. | n.t. | 0-0 | 0-1 | 3-1 | 0-1* |
| 14 | | | | | | | | | | | | |
| Example 19 | 0-0 | 0-0 | 0-1 | 0-0* | 0-0 | 0-0 | 0-0 | 0-0* | 0-0 | 0-0 | 0-0 | 0-0* |
| Example 21 | 0-0 | n.t. | 0-0 | 0-0 | 0-0 | n.t. | 0-0 | 0-0 | 0-0 | n.t. | 0-0 | 0-0 |

(n.t. = not tested)

Example 19 exhibited very good performance regarding surface marking. However, Comparative Examples do not perform as well at longer exposure to UV radiation. The asterisk shown in Example 19 represents adhesive residue which is undesirable. This transfer of small amounts of adhesive residue occurs during peel-of and is believed to be an indicator of a breakdown of the adhesive formulation. However, it is believed that this can be addressed by the incorporation of a UV absorbing material into the removable adhesive layer. Example 21 was prepared including the necessary weatherization improvements implemented in the permanent adhesive layer and the carrier resulting in an extensive UV protection to the removable adhesive layer. The result is a clean peel off of the car cover from the various clear coat surfaces without any adhesive residues even after being exposed to UV irradiation during an extensive period of time in an accelerating aging test.

Peel strength as described in Evaluation I was performed on panels with curing under Standard Baking. The results in N/cm are presented in the following Table 5.

TABLE 5

| | Clear coat: | | | | | | | | | | | |
|---|---|---|---|---|---|---|---|---|---|---|---|---|
| | Coat A | | | | Coat B | | | | Coat C | | | |
| Adhesive: | 0 h | 400 | 800 | 1600 | 0 h | 400 | 800 | 1600 | 0 h | 400 | 800 | 1600 |
| Comp Ex 1 | 2.45 | 3.24 | 2.92 | 3.35 | 2.68 | 3.2 | 2.89 | 3.44 | 2.90 | 3.64 | 2.98 | 3.84 |
| Comp Ex 2 | 0.56 | 1.16 | 1.32 | 1.72 | 0.93 | 1.8 | 1.6 | 2.40 | 1.76 | 2.59 | 2.48 | 2.43 |
| Comp Ex. | n.t. | n.t. | n.t. | n.t. | n.t. | n.t. | n.t. | n.t. | 3.69 | 5.27 | 5.26 | 6.05 |
| 13 | | | | | | | | | | | | |
| Comp Ex | n.t. | n.t. | n.t. | n.t. | n.t. | n.t. | n.t. | n.t. | 5.72 | 8.92 | 11.1 | 11.7 |
| 14 | | | | | | | | | | | | |
| Example 19 | 5.82 | 8.01 | 6.68 | 7.20 | 6.95 | 7.9 | 7.76 | 7.89 | 6.41 | 8.45 | 7.79 | 7.21 |
| Example 21 | 6.7 | n.t. | 8.0 | 7.6 | 5.7 | n.t. | 7.5 | 7.4 | 6.2 | n.t. | 8.3 | 7.9 |

Example 19 exhibits nearly constant peel strength over time and under UV exposure. However, Comparative Examples 2, 13 and 14 all show an increase in peel strength over time under UV exposure. This is believed to be an indicator of chemical interaction with the clear coat which leads to the irreversible damage to the surface. Example 21 exhibits (like Example 19) nearly constant peel strength over time and under UV exposure, but leaves no adhesive residues on the various clearcoat surfaces.

What is claimed is:

1. A cover for protecting a partially cured paint surface comprising:
a) a, breathable membrane having an outer surface and an inner surface and a peripheral edge, that is liquid water impermeable, moisture vapor permeable with a moisture vapor transmission rate between about 500 and about 5000 g/m² per 24 hours and having a Gurley Hill porosity of less than about 25 seconds; and
b) an adhesive tape for attaching the cover to the paint surface, the tape comprising:
(i) a permanent adhesive layer covering the inner surface of the membrane along the peripheral edge of the cover,
(ii) a removable adhesive layer that contacts the painted surface; and
(iii) a carrier layer positioned between the permanent adhesive layer and the removable adhesive layer,
wherein the peel strength of the removable adhesive layer at the paint surface is lower than the peel strength of the permanent adhesive layer at the membrane.

2. The cover of claim 1, wherein the membrane is formed of a polymer selected from the group consisting of polyethylene, polypropylene, polyesters, acetyl polyoxymethylene resin and polyamides.

3. The cover of claim 2, wherein the membrane comprises a flash-spun plexifilamentary film-fibril polyethylene.

4. The cover of claim 1, wherein at least one of the membrane, the permanent adhesive layer, the removable adhesive layer and the carrier layer contain an ultraviolet blocker.

5. The cover of claim 1, wherein the membrane has a surface energy lower than the surface energy of the partially cured paint surface.

6. The cover of claim 1, wherein the removable adhesive layer has a tensile modulus similar to or less than the tensile modulus of the partially cured (or fully cured) paint surface.

7. The cover of claim 1, wherein, the permanent adhesive layer comprises an adhesive selected from the group consisting of acrylic-based adhesives, rubber-based adhesives including butyl rubber and styrene butadiene rubber, hot melt adhesive, and block copolymer adhesives.

8. The cover of claim 1, wherein the removable adhesive layer comprises an adhesive selected from the group consisting of rubber, block copolymer, butyl rubber and styrene butadiene rubber, and wherein the removable adhesive is chemically inert at the interface with the paint.

9. The cover of claim 1, wherein the removable adhesive layer further comprises an additive selected from the group consisting of UV stabilizers, antioxidants and tackifiers.

10. The cover of claim 1, wherein the tape has a width of between about 10 mm and about 100 mm; the permanent adhesive layer has a thickness between about 20 micrometers and about 60 micrometers; and the removable adhesive layer has a thickness between about 30 micrometers and about 80 micrometers.

11. The cover of claim 1, further comprising a release liner covering the removable adhesive layer wherein the release liner comprises a well cured, low adhesion, smooth coating.

12. The cover of claim 1, further comprising a second multilayer, differential adhesive tape parallel to the tape of claim 1 and located a distance of less than about 5 millimeters from the tape of claim 1.
